(19) United States
(12) Patent Application Publication
(10) Pub. No.: US 2021/0271491 A1
(43) Pub. Date: Sep. 2, 2021

(54) APPLICATION PROCESSING METHOD, DEVICE, ELECTRONIC DEVICE AND STORAGE MEDIUM

(71) Applicant: BOE TECHNOLOGY GROUP CO., LTD., Beijing (CN)

(72) Inventor: Yingjie LI, Beijing (CN)

(21) Appl. No.: 17/253,295

(22) PCT Filed: Apr. 27, 2020
(86) PCT No.: PCT/CN2020/087314

§ 371 Date: Dec. 17, 2020

(30) Foreign Application Priority Data
Jun. 20, 2019 (CN) 201910539446.4

(51) Int. Cl. G06F 9/445; G06F 9/451; H04L 29/08

(52) U.S. Cl. CPC G06F 9/44505; H04L 67/306; G06F 9/451

(57) ABSTRACT

The present disclosure provides an application processing method, device, electronic device and storage medium. The method includes displaying a target application installed in the terminal after launching a desktop application; acquiring a plurality of accounts added by a user for the target application; creating an application entry corresponding to each of the accounts, wherein the application entry is configured to access the target application; and setting storage space corresponding to each of the application entries.

### CROSS-REFERENCE TO RELATED APPLICATION

The present application is a 35 U.S.C. § 371 national phase application of International Application No. PCT/CN2020/087314, filed Apr. 27, 2020, which claims the benefit of and priority to Chinese Patent Application No. 201910539446.4, filed on Jun. 20, 2019, the contents of which are hereby incorporated by reference in their entireties herein.

### TECHNICAL FIELD

The present disclosure relates to the field of application management technologies and, in particular, to an application processing method, device, electronic device, and storage medium.

### BACKGROUND

Smart devices (such as smart phones, etc.) have become popular in people's lives and work, and applications, commonly referred to as “APPs”, used on the smart devices are becoming increasingly diversified.

During the use of the smart devices, an APP installed may be used by multiple users. For example, parents and children share a mobile phone and use the same APP in common; or a user uses the APP and two different accounts for work and daily life, etc.

It should be noted that the information disclosed in the Background section above is only for enhancing the understanding of the background of the present disclosure, and thus may include information that does not constitute prior art known to those of ordinary skill in the art.

### SUMMARY

The present disclosure provides an application processing method, device, electronic device, and storage medium.

The present disclosure discloses an application processing method applied to a terminal, including:

displaying a target application installed in the terminal after launching a desktop application;

acquiring a plurality of accounts added by a user for the target application;

creating an application entry corresponding to each of the accounts, wherein the application entry is configured to access the target application; and

setting storage space corresponding to each of the application entries.

Optionally, before the step of displaying a target application installed in the terminal after launching a desktop application, the method further includes:

creating an application list in the desktop application;

acquiring at least one application installed in the terminal; and

adding the at least one application to the application list, wherein the at least one application includes the target application.

Optionally, the step of acquiring a plurality of accounts added by a user for the target application includes:

monitoring an account addition operation performed by the user on the target application in the application list; and

acquiring the plurality of accounts input by the user according to the account addition operation.

Optionally, after the step of creating an application entry corresponding to each of the accounts, the method further includes:

creating a shortcut login icon corresponding to each of the application entries, and an icon name corresponding to each of the shortcut login icons; and

adding each of the shortcut login icons and icon names to the application list.

Optionally, after the step of adding each of the shortcut login icons and icon names to the application list, the method further includes:

receiving a login operation associated with a first shortcut login icon selected from the plurality of shortcut login icons performed by the user, wherein the first shortcut login icon is one of the plurality of shortcut login icons; and

launching the target application according to the login operation, and logging in an account corresponding to the first shortcut login icon in the target application.

Optionally, after the step of adding each of the shortcut login icons and icon names to the application list, the method further includes:

deleting a second shortcut login icon in the application list when receiving a deletion operation performed by the user on the second shortcut login icon, wherein the second shortcut login icon is one of the plurality of shortcut login icons; and

deleting a second application entry corresponding to the second shortcut login icon, and clearing pre-saved storage data corresponding to the second application entry, wherein the second application entry is one of the application entries.

Optionally, the step of creating a shortcut login icon corresponding to each of the application entries, and an icon name corresponding to each of the shortcut login icons includes:

receiving a third shortcut login icon and a target icon name set by the user for the application entry sequentially, for each of the application entries; and

creating the third shortcut login icon corresponding to the application entry, and the target icon name corresponding to the third shortcut login icon.

The present disclosure discloses an application processing device, applied to a terminal, and including:

a target application display module, configured to display a target application installed in the terminal after launching a desktop application;

an addition account acquisition module, configured to acquire a plurality of accounts added by a user for the target application;

an application entry creation module, configured to create an application entry corresponding to each of the accounts, wherein the application entry is configured to access the target application; and

a storage space setting module, configured to set storage space corresponding to each of the application entries.

Optionally, the device also includes:

an application list creation module, configured to create an application list in the desktop application;

an application acquisition module, configured to acquire at least one application installed in the terminal; and

an application addition module, configured to add the at least one application to the application list, wherein the at least one application includes the target application.

Optionally, the addition account acquisition module includes:

an account addition operation monitoring sub-module, configured to monitor an account addition operation performed by the user on the target application in the application list; and

a multi-account acquisition sub-module, configured to obtain the plurality of accounts input by the user according to the account addition operation.

Optionally, the device also includes:

an icon and account creation module, configured to create a shortcut login icon corresponding to each of the application entries, and an icon name corresponding to each of the shortcut login icons; and

an icon and account addition module, configured to add each of the shortcut login icons and icon names to the application list.

Optionally, the device also includes:

a login operation receiving module, configured to receive a login operation associated with a first shortcut login icon selected from the plurality of shortcut login icons performed by the user, wherein the first shortcut login icon is one of the plurality of shortcut login icons; and

an account login module, configured to launch the target application according to the login operation, and log an account corresponding to the first shortcut login icon in the target application.

Optionally, the device also includes:

a second icon deletion module, configured to delete a second shortcut login icon in the application list when receiving a deletion operation performed by the user on the second shortcut login icon, wherein the second shortcut login icon is one of the plurality of shortcut login icons; and

an entry and data deletion module, configured to delete a second application entry corresponding to the second shortcut login icon, and clear pre-saved storage data corresponding to the second application entry, wherein the second application entry is one of the application entries.

Optionally, the icon and account creation module includes:

a third icon receiving sub-module, configured to receive a third shortcut login icon and a target icon name set by the user for the application entry sequentially, for each of the application entries; and

a third icon creation sub-module, configured to create the third shortcut login icon corresponding to the application entry, and the target icon name corresponding to the third shortcut login icon.

The present disclosure discloses an electronic device, including:

a processor;

a memory for storing executable instructions of the processor;

wherein, the processor is configured to execute any one of the application processing methods described above.

The present disclosure discloses a computer-readable medium having instructions stored thereon, and the instructions, when executed by a processor, causes the processor to execute any one of the application processing methods described above.

It should be noted that the above general description and the following detailed description are merely exemplary and explanatory and should not be construed as limiting of the disclosure.

This section provides an overview of various implementations or examples of the technologies described in the present disclosure, but is not a comprehensive disclosure of the full scope or all features of the disclosed technologies.

### BRIEF DESCRIPTION OF THE DRAWINGS

FIG.1 shows a flowchart of steps of an application processing method provided by an embodiment of the present disclosure;

FIG. 2 shows a schematic diagram of a desktop application provided by an embodiment of the present disclosure;

FIG. 3 shows a flowchart of steps of an application processing method provided by an embodiment of the present disclosure;

FIG. 4 shows a schematic structural diagram of an application processing device provided by an embodiment of the present disclosure;

FIG. 5 shows a schematic structural diagram of an application processing device provided by an embodiment of the present disclosure;

FIG. 6 shows a schematic diagram of an electronic device provided by an embodiment of the present disclosure; and

FIG. 7 shows a schematic diagram of a computer-readable medium provided by an embodiment of the present disclosure.

### DETAILED DESCRIPTION

In order to make the above objectives, features and advantages of the present disclosure more apparent and understandable, the present disclosure will be further described in detail below in conjunction with the accompanying drawings and specific embodiments.

In order to solve a problem of a plurality of accounts in the same APP, in a comparative example of the present disclosure, there is provided an application multi-launching method. The application multi-launching requires resource isolation when launching the APP process, and a new disk partition needs to be established for data isolation. In this way, if the APP is launched more, more partitions are required, and a disk capacity occupancy rate is high, but a utilization rate is low.

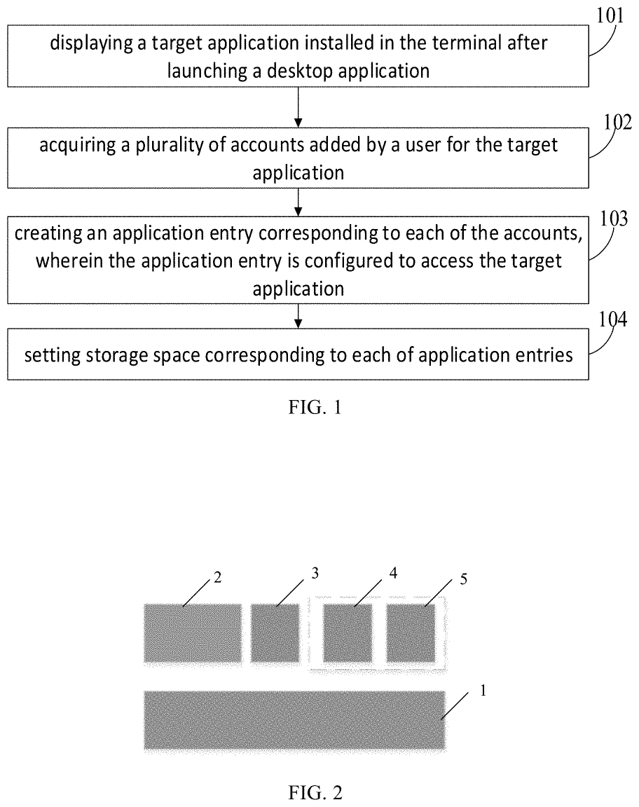

FIG. 1 shows a flowchart of steps of an application processing method provided by an embodiment of the present disclosure, and with reference to FIG. 1, the application processing method may be applied to a terminal, and specifically may include the following steps:

in step 101, a target application installed in the terminal is displayed after launching a desktop application.

The application processing method provided by the embodiment of the present disclosure mainly involves modifications of an application layer desktop application (e.g., Launcher). An architecture provided by the embodiments of the present disclosure will first be described in detail with reference to FIG. 2 as follows.

Referring to FIG. 2, which shows a schematic diagram of a desktop application provided by an embodiment of the present disclosure, and as shown in FIG. 2: 1: framework layer, 2: desktop application (such as, a launcher program), 3: APP user 1, 4: APP user . . . ; 5: APP user N. As shown in FIG. 2, the embodiments of the present disclosure do not involve improvements of the framework layer. The framework layer 1 is a layer in which the Android system provides an API layer for the application layer, and also includes the C/C++ API (Application Programming Interface) for calling Linux commands. The desktop application 1 is responsible for displaying the installed APPs, including an APK package installed through the system, and an APP entry generated for an APP adding a user, which is similar to a shortcut. “APP user 1” represents an entity APP, an application icon and name of the APP are consistent with the content of a software package. “APP user x” is an APP entry displayed on the desktop application, and the dotted box is only a shortcut-like entry representation, not the APP entity.

It should be understood that, in this embodiment, an application applied to the Android system is taken as an example for description, but it should be understood that the present disclosure is not limited to application in the Android system. The present disclosure can be applied to the operating system and/or firmware of other smart devices.

Implementations of the embodiments of the present disclosure will be described in detail below in conjunction with specific steps.

In the embodiments of the present disclosure, the terminal may be a PC (Personal Computer) terminal, and the PC terminal may be an electronic device such as a desktop computer, a notebook computer, and the like. The terminal may also be a mobile terminal, such as a mobile electronic device such as a mobile phone, a PAD (Portable Android Device).

The type of electronic device of the terminal can be determined according to business requirements, which is not limited in the embodiments of the present disclosure.

The desktop application can be the Launcher program, which refers to an application that starts first after the Android system is launched. During the startup process, the application Launcher will request the PackageManagerService to return information of installed applications in the system and encapsulate the information into a list of shortcut icons which is displayed on a system screen, so that users can click on these shortcut icons to launch the corresponding application.

The target application refers to an application that has been downloaded and installed on the terminal side. The target application can be a chat application or a financial application. Specifically, it can be determined according to actual conditions, which is not limited in the embodiments of the present disclosure.

After the Android system is started, the desktop application can be launched, or the user can click the icon of the desktop application on the terminal interface to trigger the launch of the desktop application.

After the desktop application is launched, the target application installed on the terminal can be displayed on the start interface of the desktop application, and step 102 is executed.

In the step 102, a plurality of accounts added by a user for the target application are acquired.

The plurality of accounts refers to a plurality of accounts corresponding to a single target application in the same terminal.

The plurality of accounts can be a plurality of accounts set by the same user for the target application. For example, for a work-type APP, the user can set a work account, set a family account, and so on. The plurality of accounts may also be accounts respectively set for the target application by multiple users using the same terminal. For example, when a parent and child use the same mobile phone, the accounts are set separately for the same APP, and so on.

It is understandable that the above-mentioned examples are merely examples for better understanding of the technical solutions of the embodiments of the present disclosure, and are not intended as the only limitation to the embodiments of the present disclosure.

After the desktop application is launched, and the target application installed on the terminal is displayed on the start interface of the desktop application, the user can select the target application in the start interface and perform an operation of adding the account, and then, the plurality of accounts added by the user for the target application are received.

Of course, it can also be a case that the use only sets one account. The present disclosure aims to explain a case with a plurality of accounts. For the case of one account, the present disclosure does not limit it.

After acquiring the plurality of accounts added by the user for the target application, step 103 is executed.

In the step 103, an application entry corresponding to each of the accounts is created, wherein the application entry is configured to access the target application.

The application entry refers to an entry for accessing the target application. That is, the application can be logged in directly by means of the application entry.

After acquiring the plurality of accounts added by the user for the target application, the application entry corresponding to each of the accounts can be created. For example, the plurality of accounts includes account A and account B. An application entry corresponding to the account A is entry “a” and an application entry corresponding to the account B is entry “b”, that is, the target application can be started through the entry “a” and the account A is logged in; and the target application can be started through the entry “b” and the account B is logged in.

It is understandable that the above-mentioned examples are merely examples for better understanding of the technical solutions of the embodiments of the present disclosure, and are not intended as the only limitation to the embodiments of the present disclosure.

After creating the application entry corresponding to each of the accounts, step 104 is executed.

In the step 104, storage space corresponding to each of the application entries is set.

After creating the application entry corresponding to each of the accounts, the storage space corresponding to each of the application entries can also be set in the terminal system.

The storage space defined in the embodiments of the present disclosure can be a file used for storing data. In the case of a plurality of accounts, directories (that is, storage paths) of the storing files corresponding to respective accounts can be set separately. After a certain account is launched, and when interactive data is generated, the interactive data can be saved in the storage file corresponding to the account according to the storage path corresponding to the account.

In the implementation provided by the embodiments of the present disclosure, it is possible to switch the account by clicking the application entry of the account to be logged in in the start interface corresponding to the desktop application under the situation that only the application layer Launcher code is modified, which achieves fast switching of different accounts in the same application. In addition, by means of the storage space corresponding to each of the application entries, data isolation of different accounts of the same APP can be realized without the need to create a new disk partition, which can reduce the occupancy rate of disk capacity.

In the application processing method provided by the embodiments of the present disclosure, the target application installed in the terminal is displayed after launching the desktop application, and the plurality of accounts added by the user for the target application are acquired, and the application entry corresponding to each of the accounts is created, and the application entry is configured to access the target application. In addition, the storage space corresponding to each of the application entries is set. By setting respective application entries for the multiple account of the target application, respectively, and the storage space corresponding to each of the application entry in the embodiments of the present disclosure, it avoids establishing a new partition for each account for the purpose of data isolation, and the occupancy rate of the disk capacity is reduced, and the utilization rate of the disk capacity is improved.

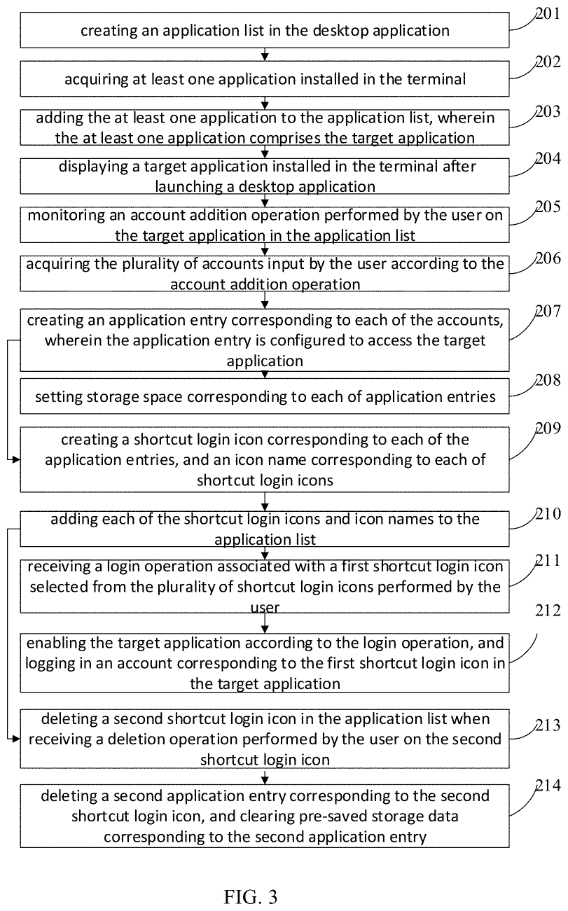

FIG. 3 shows a flowchart of steps of an application processing method provided by an embodiment of the present disclosure. With reference to FIG. 3, the application processing method may be applied to the terminal, and specifically may include the following steps:

In step 201, an application list is created in the desktop application.

The application processing method provided by the embodiment of the present disclosure mainly involves modifications of an application layer desktop application (e.g., Launcher). An architecture provided by the embodiments of the present disclosure will first be described in detail with reference to FIG. 2 as follows.

Referring to FIG. 2, which shows a schematic diagram of a desktop application provided by an embodiment of the present disclosure, and as shown in FIG. 2: 1: framework layer, 2: desktop application (such as, a launcher program), 3: APP user 1, 4: APP user . . . ; 5: APP user N. As shown in FIG. 2, the embodiments of the present disclosure do not involve improvements of the framework layer. The framework layer 1 is a layer in which the Android system provides an API layer for the application layer, and also includes the C/C++ API (Application Programming Interface) for calling Linux commands. The desktop application 1 is responsible for displaying the installed APPs, including an APK package installed through the system, and an APP entry generated for an APP adding a user, which is similar to a shortcut. “APP user 1” represents an entity APP, an application icon and name of the APP are consistent with the content of a software package. “APP user x” is an APP entry displayed on the desktop application, and the dotted box is only a shortcut-like entry representation, not the APP entity.

The implementations of the embodiments of the present disclosure will be described in detail below in conjunction with specific steps.

In the embodiments of the present disclosure, the terminal may be a PC (Personal Computer) terminal, and the PC terminal may be an electronic device such as a desktop computer, a notebook computer, and the like. The terminal may also be a mobile terminal, such as a mobile electronic device such as a mobile phone, a PAD (Portable Android Device).

The desktop application can be the Launcher program, which refers to an application that starts first after the Android system is launched. During the startup process, the application Launcher will request the PackageManagerService to return information of installed applications in the system and encapsulate the information into a list of shortcut icons which is displayed on a system screen, so that users can click on these shortcut icons to launch the corresponding application.

The application list refers to a list used for adding the installed applications in the terminal in the creation of the desktop application startup list. The application list can display information such as application icons and names, which depends on the business needs specifically.

After the application list is created in the desktop application, step 202 is executed.

In the step 202, at least one application installed in the terminal is acquired.

The at least one application refers to an application that has been downloaded and installed on the terminal side, and the type of the application can be determined according to actual conditions, which is not limited in the embodiments of the present disclosure.

After acquiring the at least one application installed in the terminal, step 203 is executed.

In the step 203, the at least one application is added to the application list, and the at least one application includes the target application.

The target application refers to an application that has been downloaded and installed on the terminal, in which multiple accounts are set by the user in the subsequent processes. The target application can be a chat application or a financial application. Specifically, it can be determined according to actual conditions, which is not limited in the embodiments of the present disclosure.

After acquiring the at least one application installed in the terminal, the at least one application may be added to the application list, and step 204 is executed.

In the step 204, the target application installed in the terminal is displayed after launching the desktop application.

After the Android system is started, the desktop application can be launched, or the user can click the icon of the desktop application on the terminal interface to launch of the desktop application.

After the desktop application is launched, the target application installed on the terminal can be displayed on the start interface of the desktop application, and step 205 is executed.

In the step 205, an account addition operation performed by the user on the target application is monitored the in the application list.

The account addition operation refers to an operation performed in the application list to add an account to the target application.

The account addition operation can be an account addition operation triggered by the user manually. An “add” button can be preset after each application in the application list. After the user clicks the button, an account addition interface (such as username+password, etc.) can be displayed, and an operation that the user clicks the “add” button can be regarded as the account addition operation.

Of course, the account addition operation may also be another form of account addition operation performed by the user, such as the user inputting a voice for adding an account, etc., specifically, it may be determined according to business requirements.

It is understandable that the above-mentioned examples are merely examples for better understanding of the technical solutions of the embodiments of the present disclosure, and are not intended as the only limitation to the embodiments of the present disclosure.

After monitoring the account addition operation performed by the user on the target application in the application list, step 206 is executed.

In the step 206, the plurality of accounts input by the user are acquired according to the account addition operation.

After monitoring the account addition operation performed by the user on the target application, the plurality of accounts (such as username+password, etc.) input by the user may be received, and step 207 is executed.

In the step 207, an application entry corresponding to each of the accounts is created, wherein the application entry is configured to access the target application.

After acquiring the plurality of accounts added by the user for the target application, the application entry corresponding to each of the accounts can be created. For example, the plurality of accounts includes account A and account B. An application entry corresponding to the account A is entry “a” and an application entry corresponding to the account B is entry “b”, that is, the target application can be started through the entry “a” and the account A is logged in; and the target application can be started through the entry “b” and the account B is logged in.

It is understandable that the above-mentioned examples are merely examples for better understanding of the technical solutions of the embodiments of the present disclosure, and are not intended as the only limitation to the embodiments of the present disclosure.

After creating the application entry corresponding to each of the accounts, step 208 or step 209 is executed.

In the step 208, storage space corresponding to each of the application entries is set.

After creating the application entry corresponding to each of the accounts, the storage space corresponding to each of the application entries can also be set in the terminal system.

Specifically, after the shortcut login icon and the name of the application entry are edited, a directory corresponding to the user data is automatically created under a /data/data/ directory and a /sdcard/Android/data/ directory. The directory name, when one APP corresponds to the multiple user entries, will not be repeated, which can be named according to chronological order of creation along with an original APP package name, such as com.xxx.xxx_1, com.xxx.xxx_2, . . . , com.xxx.xxx_n.

The storage space defined in the embodiments of the present disclosure can be a file used for storing data. In the case of multiple accounts, directories (that is, storage paths) of the storing files corresponding to respective accounts can be set separately. After a certain account is launched, and when interactive data is generated, the interactive data can be saved in the storage file corresponding to the account according to the storage path corresponding to the account.

In the step 209, a shortcut login icon corresponding to each of the application entries, and an icon name corresponding to each of the shortcut login icons are created.

The shortcut login icon refers to an icon displayed in the application list and used for quickly log in to a certain account of the target application.

In the application list, corresponding shortcut login icons can be created for different application entries, respectively, that is, each account corresponds to one shortcut login icon, so that quick login of a plurality of accounts corresponding to the target application can be realized in the application list. For example, the application entries include entry “a”, entry “b”, and entry “c”. A shortcut login icon 1 can be created for the entry “a”, a shortcut login icon 2 can be created for the entry “b”, and a shortcut login icon 3 can be created for the entry “c”.

Of course, each shortcut login icon corresponds to an icon name, and the icon name can be associated with the corresponding account name, and the specific account can be quickly identified in the displayed application list, which prevents the user from misremembering the shortcut login icons corresponding to different accounts.

Of course, the above process can be described in detail in the following specific implementation manner as follows.

In a specific implementation of the present disclosure, the above step 209 may include:

in sub-step A1, for each of the application entries, a third shortcut login icon and a target icon name set by the user for the application entry are received sequentially.

The third shortcut login icon refers to a shortcut login icon created for a certain account of the target application.

The target icon name refers to an icon name corresponding to the third shortcut login icon.

After creating the application entries for the plurality of accounts, respectively, the third shortcut login icon and the target icon name set by the user for the application entry are received sequentially for each of the application entries. That is, the user selects the icon, and after the user selects the icon, the terminal crops a picture corresponding to the icon according to the icon selected by the user, and a size of the picture can be the same as an icon size in the original APP package.

It is understandable that the above-mentioned examples are merely examples for better understanding of the technical solutions of the embodiments of the present disclosure, and are not intended as the only limitation to the embodiments of the present disclosure.

In sub-step A2, the third shortcut login icon corresponding to the application entry, and the target icon name corresponding to the third shortcut login icon are created.

After receiving the third shortcut login icon and a target icon name set by the user for the application entry, the terminal can create the corresponding third shortcut login icon for the application entry, that is, associating the third shortcut login icon with the application entry. When the third shortcut login icon is clicked, the application entry can be launched to start the target application and log in to a specified account.

Meanwhile, the terminal can also add the target icon name at the corresponding position of the third shortcut icon in the application list according to the target icon name set by the user for different accounts, so that different accounts corresponding to the target application can be distinguishable.

In the embodiments of the present disclosure, the icon and name corresponding to each account among the plurality of accounts of the target application can be set by the user, which can realize the personalized setting of the user and facilitate the user to distinguish different accounts of the same application.

In step 210, each of the shortcut login icons and icon names are added to the application list.

After creating the shortcut login icon corresponding to each of the application entries and the icon name corresponding to each shortcut login icon, each shortcut login icon and each icon name can be added to the application list.

After adding each of the shortcut login icons and icon names to the application list, step 211 is executed.

In the step 211, a login operation associated with a first shortcut login icon selected from the plurality of shortcut login icons performed by the user is received/

In the embodiment of the present disclosure, the first shortcut login icon is one of the plurality of shortcut login icons.

The login operation may be a login operation initiated by the user clicking the first shortcut login icon.

After adding each shortcut login icon and each icon name corresponding to each shortcut login icon to the application list, the login operation initiated by the user clicking the first shortcut login icon can be received.

After receiving the login operation associated with the first shortcut login icon performed by the user, step 212 is performed.

In the step 212, the target application is launched according to the login operation, and an account corresponding to the first shortcut login icon is logged in in the target application.

After receiving the login operation associated with the first shortcut login icon, the target application can be started, and the account corresponding to the first shortcut login icon can be logged in the target application.

In the embodiments of the present disclosure, in the application list, fast login of different accounts of the same application can be realized, and fast switching operations of different accounts can be realized.

In step 213, a second shortcut login icon is deleted in the application list when a deletion operation performed by the user on the second shortcut login icon is received.

In the embodiment of the present disclosure, the second shortcut login icon is one of the plurality of shortcut login icons.

The deletion operation refers to an operation of deleting the shortcut login icon performed by the user in the application list.

In the application list, a “Delete” button can be preset after each shortcut login icon. The user can click the “Delete” button corresponding to the second shortcut login icon in the application list to trigger the deletion operation of the second shortcut login icon.

After receiving the deletion operation performed by the user on the second shortcut login icon, the second shortcut login icon may be deleted from the application list, and step 214 is performed.

In the step 214, a second application entry corresponding to the second shortcut login icon is deleted, and pre-saved storage data corresponding to the second application entry is cleared.

The second application entry is an application entry corresponding to the second shortcut login icon in each of the application entries.

After deleting the second shortcut login icon in the application list, the second application entry corresponding to the second shortcut login icon can also be deleted, and according to the storage directory corresponding to the second application entry, the storage data corresponding to the second application entry is found, and the storage data is cleared, which avoids the occupation of space resources by invalid data.

In the application processing method provided by the embodiments of the present disclosure, the target application installed in the terminal is displayed after launching the desktop application, and the plurality of accounts added by the user for the target application are acquired, and the application entry corresponding to each of the accounts is created, and the application entry is configured to access the target application. In addition, the storage space corresponding to each of the application entries is set. By setting respective application entries for the multiple account of the target application, respectively, and the storage space corresponding to each of the application entry in the embodiments of the present disclosure, it avoids establishing a new partition for each account for the purpose of data isolation, and the occupancy rate of the disk capacity is reduced, and the utilization rate of the disk capacity is improved.

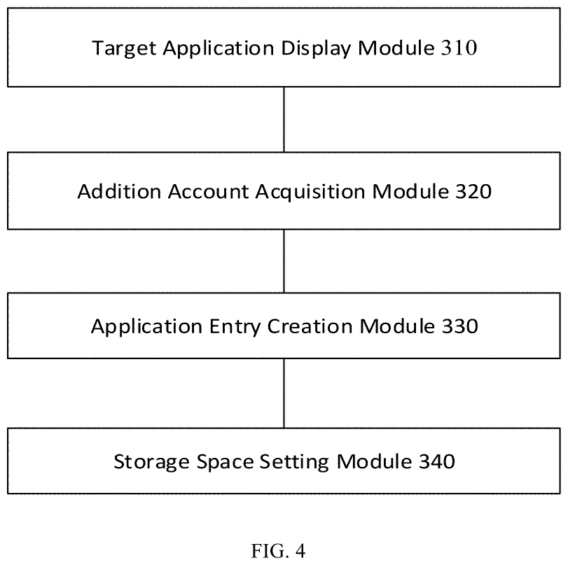

FIG. 4 shows a schematic structural diagram of an application processing device provided by an embodiment of the present disclosure. With reference to FIG. 4, the application processing device may specifically include the following modules:

a target application display module 310, configured to display a target application installed in the terminal after launching a desktop application;

an addition account acquisition module 320, configured to acquire a plurality of accounts added by a user for the target application;

an application entry creation module 330, configured to create an application entry corresponding to each of the accounts, wherein the application entry is configured to access the target application; and

a storage space setting module 340, configured to set storage space corresponding to each of the application entries.

In the present disclosure, the term “module” is used for denoting a functional entity and do not necessarily correspond to physically or logically separate entities. These functional entities may be implemented in software, or implemented in one or more hardware modules or integrated circuits, or implemented in different networks and/or processor devices and/or microcontroller devices. In some embodiments, the module may represent a program segment or a part of the code, and the program segment or a part of the code includes one or more executable instructions for implementing prescribed logical functions. It should also be noted that each module or a combination of modules can be implemented by a dedicated hardware-based system that performs prescribed functions or operations, or can be implemented by a combination of dedicated hardware and computer instructions.

In the application processing device provided by the embodiments of the present disclosure, the target application installed in the terminal is displayed after launching the desktop application, and the plurality of accounts added by the user for the target application are acquired, and the application entry corresponding to each of the accounts is created, and the application entry is configured to access the target application. In addition, the storage space corresponding to each of the application entries is set. By setting respective application entries for the multiple account of the target application, respectively, and the storage space corresponding to each of the application entry in the embodiments of the present disclosure, it avoids establishing a new partition for each account for the purpose of data isolation, and the occupancy rate of the disk capacity is reduced, and the utilization rate of the disk capacity is improved.

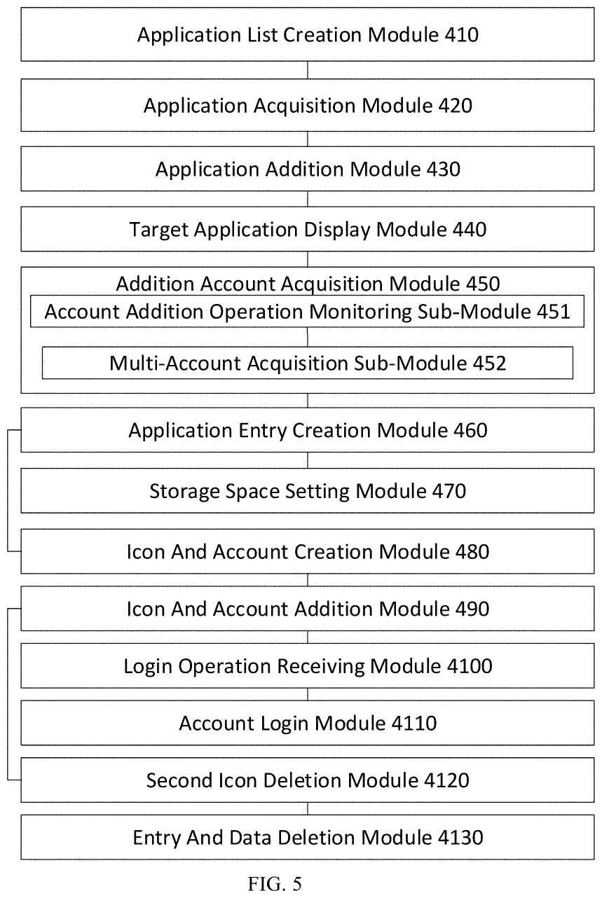

FIG. 5 shows a schematic structural diagram of an application processing device provided by an embodiment of the present disclosure. With reference to FIG. 5, the application processing device may specifically include the following modules:

an application list creation module 410, configured to create an application list in the desktop application;

an application acquisition module 420, configured to acquire at least one application installed in the terminal;

an application addition module 430, configured to add the at least one application to the application list, wherein the at least one application includes the target application;

a target application display module 440, configured to display a target application installed in the terminal after launching a desktop application;

an addition account acquisition module 450, configured to acquire a plurality of accounts added by a user for the target application;

an application entry creation module 460, configured to create an application entry corresponding to each of the accounts, wherein the application entry is configured to access the target application;

a storage space setting module 470, configured to set storage space corresponding to each of the application entries;

an icon and account creation module 480, configured to create a shortcut login icon corresponding to each of the application entries, and an icon name corresponding to each of the shortcut login icons;

an icon and account addition module 490, configured to add each of the shortcut login icons and icon names to the application list;

a login operation receiving module 4100, configured to receive a login operation associated with a first shortcut login icon selected from the plurality of shortcut login icons performed by the user, wherein the first shortcut login icon is one of the plurality of shortcut login icons;

an account login module 4110, configured to launch the target application according to the login operation, and log an account corresponding to the first shortcut login icon in the target application;

a second icon deletion module 4120, configured to delete a second shortcut login icon in the application list when receiving a deletion operation performed by the user on the second shortcut login icon, wherein the second shortcut login icon is one of the plurality of shortcut login icons; and

an entry and data deletion module 4130, configured to delete a second application entry corresponding to the second shortcut login icon, and clear pre-saved storage data corresponding to the second application entry, wherein the second application entry is one of the application entries.

Optionally, the addition account acquisition module 450 includes:

an account addition operation monitoring sub-module 451, configured to monitor an account addition operation performed by the user on the target application in the application list; and

a multi-account acquisition sub-module 452, configured to obtain the plurality of accounts input by the user according to the account addition operation.

Optionally, the icon and account creation module 480 includes:

a third icon receiving sub-module, configured to receive a third shortcut login icon and a target icon name set by the user for the application entry sequentially, for each of the application entries; and

a third icon creation sub-module, configured to create the third shortcut login icon corresponding to the application entry, and the target icon name corresponding to the third shortcut login icon.

In the application processing device provided by the embodiments of the present disclosure, the target application installed in the terminal is displayed after launching the desktop application, and the plurality of accounts added by the user for the target application are acquired, and the application entry corresponding to each of the accounts is created, and the application entry is configured to access the target application. In addition, the storage space corresponding to each of the application entries is set. By setting respective application entries for the multiple account of the target application, respectively, and the storage space corresponding to each of the application entry in the embodiments of the present disclosure, it avoids establishing a new partition for each account for the purpose of data isolation, and the occupancy rate of the disk capacity is reduced, and the utilization rate of the disk capacity is improved.

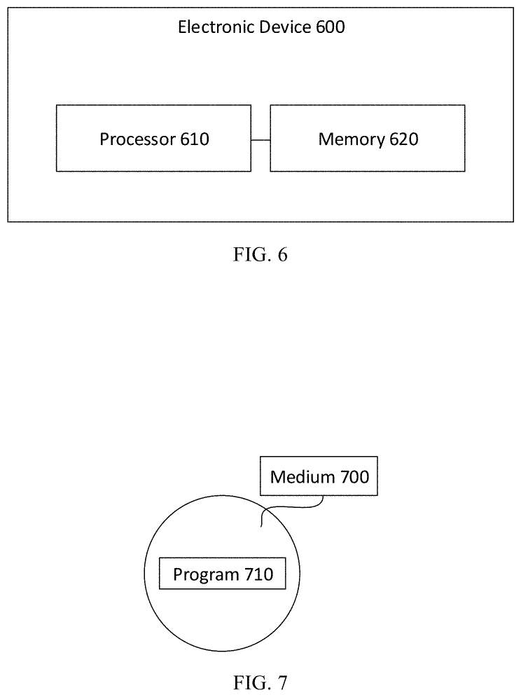

In addition, the embodiments of the present disclosure also provide an electronic device. Referring to FIG. 6, the electronic device 600 includes: a processor 610; a memory 620 for storing executable instructions of the processor. The processor 610 may be configured to run the instructions stored in the memory 620, so that the electronic device executes the application processing method in any one of the foregoing embodiments.

In addition, the embodiments of the present disclosure also provide a computer readable medium, which may include a non-transitory computer-readable storage medium. Referring to FIG. 7, the computer readable medium 700 stores a program 710. When the program 710 is run by the processor, the running may enable the processor to execute the application processing method in any one of the foregoing embodiments.

Compared with the prior art, the present disclosure includes the following advantages:

The embodiments of the present disclosure provide an application processing method, device, electronic device, and storage medium. The target application installed in the terminal is displayed after launching the desktop application, and the plurality of accounts added by the user for the target application are acquired, and the application entry corresponding to each of the accounts is created, and the application entry is configured to access the target application. In addition, the storage space corresponding to each of the application entries is set. By setting respective application entries for the multiple account of the target application, respectively, and the storage space corresponding to each of the application entry in the embodiments of the present disclosure, it avoids establishing a new partition for each account for the purpose of data isolation, and the occupancy rate of the disk capacity is reduced, and the utilization rate of the disk capacity is improved.

For the foregoing method embodiments, for the sake of simple description, they are all expressed as a series of action combinations, but those skilled in the art should know that the present disclosure is not limited by the described sequence of actions, because according to the present disclosure, some steps can be performed in other orders or simultaneously. Secondly, those skilled in the art should also know that the embodiments described in the specification are all optional embodiments, and the involved actions and modules are not necessarily required by the present disclosure.

The various embodiments in this specification are described in a progressive manner. Each embodiment focuses on the differences from other embodiments, and the same or similar parts between the various embodiments can be referred to each other.

Finally, it should be noted that in this document, relational terms such as first and second are only used to distinguish one entity or operation from another entity or operation, and do not necessarily require or imply there is any such actual relationship or sequence between these entities or operations. Moreover, the terms “include”, “contain”, or any other variants thereof are intended to cover non-exclusive inclusion, so that a process, method, product, or device that includes a series of elements includes not only those elements, but also other elements that are not explicitly listed, or include elements inherent to the process, method, product, or device. If there are no more restrictions, the element defined by the sentence “including a . . . ” does not exclude the existence of other identical elements in the process, method, commodity, or device that includes the element.

The above describes in detail the application processing method, the application processing device, and the electronic device provided in the present disclosure. Specific examples are used in this document to illustrate the principles and implementations of the present disclosure. The description of the above embodiments is only used for helping understand the methods and core ideas of the present disclosure; in addition, for those of ordinary skill in the art, according to the ideas of the present disclosure, there will be changes in the specific implementation and the scope of application. In summary, the content of this specification should not be construed as a limitation of this disclosure.

1. A computer-implemented application processing method applied to a terminal, comprising:
displaying a target application installed in the terminal after launching a desktop application;
acquiring a plurality of accounts added by a user for the target application;
creating an application entry corresponding to each of the accounts, wherein the application entry is configured to access the target application; and
setting storage space corresponding to each application entry.

2. The computer-implemented method according to claim 1, wherein, before displaying the target application installed in the terminal after launching the desktop application, the computer-implemented method further comprises:
creating an application list in the desktop application;
acquiring at least one application installed in the terminal; and
adding the at least one application to the application list, wherein the at least one application comprises the target application.

3. The computer-implemented method according to claim 2, wherein acquiring the plurality of accounts added by the user for the target application comprises:
monitoring an account addition operation performed by the user on the target application in the application list; and
acquiring the plurality of accounts input by the user according to the account addition operation.

4. The computer-implemented method according to claim 2, wherein after creating the application entry corresponding to each of the accounts, the computer-implemented method further comprises:
creating a shortcut login icon corresponding to each application entry, and an icon name corresponding to each shortcut login icon; and
adding each shortcut login icon and icon name to the application list.

5. The computer-implemented method according to claim 4, wherein after adding each shortcut login icon and icon name to the application list, the computer-implemented method further comprises:
receiving a login operation associated with a first shortcut login icon selected from a plurality of shortcut login icons performed by the user, wherein the first shortcut login icon is one of the plurality of shortcut login icons; and
launching the target application according to the login operation, and logging in an account corresponding to the first shortcut login icon in the target application.

6. The computer-implemented method according to claim 4, wherein after adding each shortcut login icon and icon name to the application list, the computer-implemented method further comprises:
deleting a second shortcut login icon in the application list when receiving a deletion operation performed by the user on the second shortcut login icon, wherein the second shortcut login icon is one of a plurality of shortcut login icons; and
deleting a second application entry corresponding to the second shortcut login icon, and clearing pre-saved storage data corresponding to the second application entry, wherein the second application entry is one of a plurality of application entries.

7. The computer-implemented method according to claim 4, wherein creating the shortcut login icon corresponding to each application entry, and an icon name corresponding to each shortcut login icon comprises:
receiving a third shortcut login icon and a target icon name set by the user for the application entry sequentially, for each application entry; and
creating the third shortcut login icon corresponding to the application entry, and the target icon name corresponding to the third shortcut login icon.

8-14. (canceled)

15. An electronic device, comprising:
at least one hardware processor;
a memory storing executable instructions thereon that, when executed by the at least one hardware processor, direct the at least one hardware processor to perform a method comprising:
displaying a target application installed in the terminal after launching a desktop application;
acquiring a plurality of accounts added by a user for the target application;
creating an application entry corresponding to each of the accounts, wherein the application entry is configured to access the target application; and
setting storage space corresponding to each application entry.

16. The electronic device according to claim 15, wherein, before the displaying the target application installed in the terminal after launching the desktop application, the method further comprises:
creating an application list in the desktop application;
acquiring at least one application installed in the terminal; and
adding the at least one application to the application list, wherein the at least one application comprises the target application.

17. The electronic device according to claim 16, wherein acquiring the plurality of accounts added by the user for the target application comprises:
monitoring an account addition operation performed by the user on the target application in the application list; and
acquiring the plurality of accounts input by the user according to the account addition operation.

18. The electronic device according to claim 16, wherein, after creating the application entry corresponding to each of the accounts, the method further comprises:
creating a shortcut login icon corresponding to each application entry, and an icon name corresponding to each shortcut login icon; and
adding each shortcut login icon and icon name to the application list.

19. The electronic device according to claim 18, wherein, after adding each shortcut login icon and icon name to the application list, the method further comprises:
receiving a login operation associated with a first shortcut login icon selected from a plurality of shortcut login icons performed by the user, wherein the first shortcut login icon is one of the plurality of shortcut login icons; and
launching the target application according to the login operation, and logging in an account corresponding to the first shortcut login icon in the target application.

20. The electronic device according to claim 18, wherein, after adding each shortcut login icon and icon name to the application list, the method further comprises:
deleting a second shortcut login icon in the application list when receiving a deletion operation performed by the user on the second shortcut login icon, wherein the second shortcut login icon is one of a plurality of shortcut login icons; and
deleting a second application entry corresponding to the second shortcut login icon, and clearing pre-saved storage data corresponding to the second application entry, wherein the second application entry is one of a plurality of application entries.

21. The electronic device according to claim 18, wherein creating the shortcut login icon corresponding to each application entry, and an icon name corresponding to each shortcut login icon comprises:
receiving a third shortcut login icon and a target icon name set by the user for the application entry sequentially, for each application entry; and
creating the third shortcut login icon corresponding to the application entry, and the target icon name corresponding to the third shortcut login icon.

22. A non-transitory computer-readable storage medium having program instructions stored thereon that, when executed by a terminal having at least one hardware processor, causes the at least one hardware processor to implement an application processing method comprising:
displaying a target application installed in the terminal after launching a desktop application;
acquiring a plurality of accounts added by a user for the target application;
creating an application entry corresponding to each of the accounts, wherein the application entry is configured to access the target application; and
setting storage space corresponding to each application entry.
